(19) United States
(12) Patent Application Publication
(10) Pub. No.: US 2008/0223663 A1
(43) Pub. Date: Sep. 18, 2008

(54) Configuration for Feeding a Lubricant to a Lubrication Point on a Revolving Part of a Printing Technology Machine

(75) Inventors: Christian Gorbing, Heidelberg (DE); Alexander Knabe, Heidelberg (DE)

Correspondence Address: LERNER GREENBERG STEMER LLP, P O BOX 2480, HOLLYWOOD, FL, 33022-2480, US

(73) Assignee: HEIDELBERGER DRUCKMASCHINEN AG, Heidelberg (DE)

(21) Appl. No.: 12/048,245

(22) Filed: Mar. 14, 2008

(30) Foreign Application Priority Data
Mar. 14, 2007 (DE) 10 2007 012 185.9

(51) Int. Cl. B23Q 11/12; B41F 13/00; F16C 33/66

(52) U.S. Cl. 184/6.14; 384/462

(57) ABSTRACT

A configuration for feeding a lubricant to a lubrication point on a revolving part of a printing technology machine includes a stationary lubricant container and a conveying device for conveying lubricant out of the container to the revolving part. A sealed antifriction bearing on the revolving part has a bearing ring fixed against rotation. At least one lubricant feed duct extends to a bearing chamber for antifriction elements of the antifriction bearing. At least one lubricant duct in the revolving part leads from the antifriction bearing to the lubrication point.

### CROSS-REFERENCE TO RELATED APPLICATION

This application claims the priority, under 35 U.S.C. §119, of German Patent Application DE 10 2007 012 185.9, filed Mar. 14, 2007; the prior application is herewith incorporated by reference in its entirety.

### BACKGROUND OF THE INVENTION

### Field of the Invention

The invention relates to a configuration for feeding a lubricant to a lubrication point at a revolving part of a printing technology machine having a stationary lubricant container with a conveying device for conveying lubricant out of the container to the revolving part.

Revolving parts, particularly cylinders, drums and rollers, are mounted in side walls on printing presses. Journals, which are seated in an inner ring of an antifriction bearing, can be formed on the parts. The outer ring of the antifriction bearing is fastened in the side wall so as to be fixed against rotation relative thereto. In order to prolong the lifetime of the bearing, it is lubricated by oil in that, for example, oil is respectively conveyed from a stationary container to the antifriction elements and the running surfaces of the latter. If appropriate, an antifriction bearing may be sealed off with disks, rings and the like.

Rotary leadthroughs have become known heretofore for supplying a lubrication point on a revolving or reciprocating part with oil or for supplying an actuator with a working fluid or for feeding a fluid for heating or cooling to a moving part. In the case of parts formed with a bearing journal, a fluid is fed to the journal radially or axially. Rotary leadthroughs are structurally complex and require an installation space which is not available for other purposes.

In the devices according to German Utility Models DE 20 2005 019 155 U1 and DE 20 2005 017 850 U1, a belt roller forms the outer ring of an antifriction bearing. Lubricant is fed to the bearing from outside through a radial drilled hole in the belt roller or from inside through axial and radial drilled holes in a bearing journal. The bearing is re-lubricated from time to time with a defined quantity of grease.

European Application EP 1 060 881 A1, corresponding to U.S. Pat. No. 6,308,621, discloses a lubricating and cooling apparatus for a bearing of a cylinder of a printing press, wherein oil is fed under pressure to the bearing in a closed circuit including a pump. The bearing is enclosed by a gearbox casing, which has a respective opening for the supply and discharge of the oil. The supply of oil is such that flow through the bearing takes place in the axial direction.

In order to lubricate an antifriction bearing of a printing press, according to German Published, Non-prosecuted Patent Application DE 44 38 483 A1, corresponding to U.S. Pat. No. 5,484,212, lubricant is fed by a pump through a groove and drilled holes or bores formed in an outer ring of the bearing. The bearing is kept open, whereby a distribution of the lubricant to the bearing surfaces and antifriction elements is achieved by blown air.

A factor that is common to the antifriction bearing lubrication systems according to the prior art is that lubricant is fed precisely to one bearing and exerts its action thereat. The devices are not suitable for lubricating a bearing on a revolving part, the bearing surfaces and antifriction elements of which are not accessible through an outer ring which is fixed against rotation or separate rotary leadthroughs.

### SUMMARY OF THE INVENTION

It is accordingly an object of the invention to provide a configuration for feeding a lubricant to a lubrication point on a revolving part of a printing technology machine, which overcomes the hereinafore-mentioned disadvantages of the heretofore-known devices of this general type and which, with relatively little outlay, permits the lubrication of a bearing that is difficult to access.

With the foregoing and other objects in view, there is provided in accordance with the invention, a configuration for feeding a lubricant to a lubrication point on a revolving part of a printing technology machine. The configuration comprises a stationary lubricant container, a conveying device for conveying lubricant out of the container to the revolving part, a sealed antifriction bearing disposed on the revolving part, the antifriction bearing having a bearing ring fixed against rotation and a bearing chamber for antifriction elements, at least one lubricant feed duct extending to the bearing chamber, and at least one lubricant duct disposed in the revolving part and leading from the antifriction bearing to the lubrication point.

In accordance with another feature of the invention, for feeding the lubricant, the antifriction bearing is a radial antifriction bearing having an outer ring and an inner ring. The lubricant feed duct extends through the outer ring, a lubricant drain duct extends through the inner ring, and the lubricant drain duct extends to the lubricant duct provided in the revolving part.

In accordance with a further feature of the invention, for feeding the lubricant, the antifriction bearing is an axial antifriction bearing having an outer ring fixed against rotation relative thereto and a bearing ring connected to the revolving part. The lubricant feed duct is led through the outer ring, the lubricant drain duct is led through the bearing ring, and the lubricant drain duct extends to the lubricant duct in the revolving part.

In accordance with yet another feature of the invention, for feeding the lubricant, the axial antifriction bearing has an outer ring fixed against rotation relative thereto and a bearing ring connected to the revolving part. The axial antifriction bearing is enclosed by parts fixed against rotation relative thereto, and the lubricant feed duct is led to the bearing chamber through one of the enclosing parts or between two of the enclosing parts.

In accordance with a concomitant feature of the invention, the lubricant is oil, which is to be fed to the bearing chamber under pressure.

Thus, according to the invention, an antifriction bearing is formed as a rotary leadthrough for a lubricant on a revolving part. To this end, the bearing is formed so as to be sealed. A lubricant feed duct leads from a stationary lubricant supply to the bearing chamber of the antifriction elements of the bearing. A lubricant duct leads from the bearing chamber to a lubrication point on the revolving part.

Providing a rotary leadthrough with a commercially available antifriction bearing is less expensive in terms of costs and material and permits space-saving installation.

Other features which are considered as characteristic for the invention are set forth in the appended claims.

Although the invention is illustrated and described herein as embodied in a configuration for feeding a lubricant to a lubrication point on a revolving part of a printing technology machine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a fragmentary, diagrammatic, front-elevational view of an assembly for feeding oil through a radial bearing;

FIG. 2 is an enlarged, fragmentary, sectional view of an assembly for feeding oil through an axial bearing; and

FIG. 3 is a fragmentary, sectional view of a variant of the view according to FIG. 2.

### DETAILED DESCRIPTION OF THE INVENTION

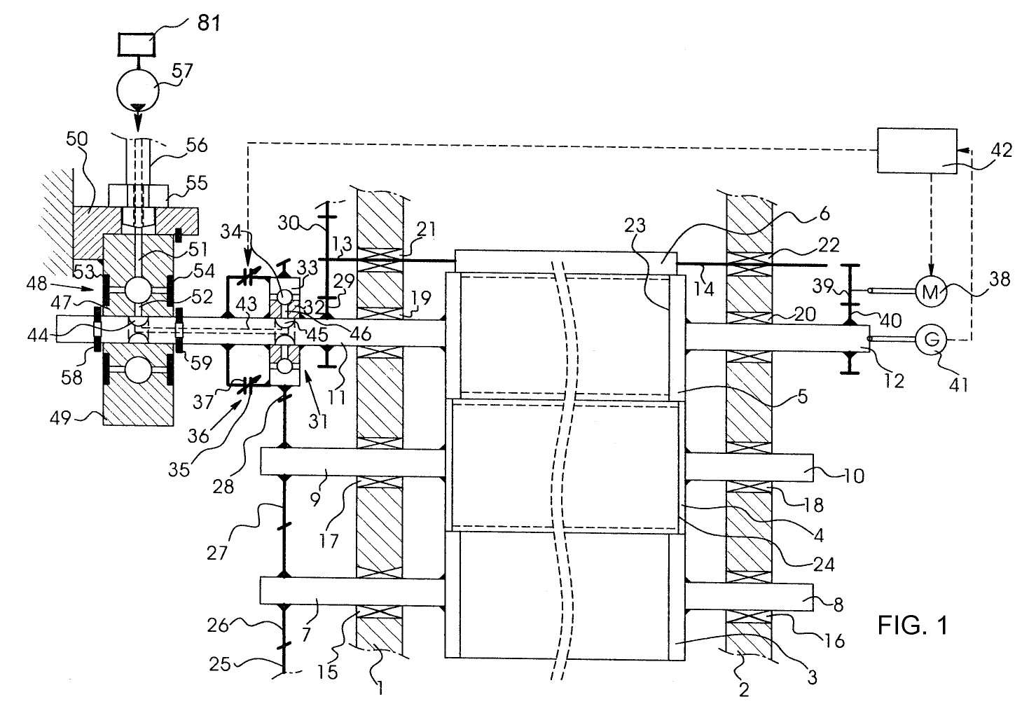

Referring now to the figures of the drawings in detail and first, particularly, to FIG. 1 thereof, there is seen a fragmentary, diagrammatic view of a portion of a printing unit of an offset printing press. An impression cylinder 3, a transfer cylinder 4, a plate cylinder 5 and an ink roller 6 are mounted between side walls 1 and 2. The cylinders 3 to 5 and the ink roller 6 are held by respective journals 7 to 14 in respective bearings 15 to 22, which are disposed in the side walls 1 and 2. A printing form 23 is drawn onto the plate cylinder 5. The transfer cylinder 4 has a resilient cover 24.

A main drive train having gear wheels 25 to 30 is provided in order to drive the cylinders 3 to 5 and the roller 6. The gear wheels 26, 27, 29, 30 are disposed on the respective journals 7, 9,11,13 so as to be fixed against rotation relative thereto. The gear wheel 28 is held rotatably with an antifriction bearing 31 on the journal 11. The antifriction bearing 31 includes an inner ring 32, an outer ring 33 and antifriction or roller elements 34. The inner ring 32 is seated firmly on the journal 11 so as to be rotatable therewith. The gear wheel 28 is fixed to the outer ring 33. The outer ring 33 is connected to a first coupling half 35 of a toothed engagement coupling 36. A second coupling half 37 of the toothed coupling 36 is fixed to the journal 11.

When the coupling 36 is disengaged, the plate cylinder 5 is drivable by an auxiliary motor 38. The motor 38 is coupled with a gear wheel 39, which is in engagement with a gear wheel 40. The gear wheel 40 is firmly seated on the journal 12 so as to be rotatable therewith. A rotary encoder 41 which is disposed on the journal 12 continuously measures the rotational position of the plate cylinder 5. The coupling 36 is remotely actuatable by a control device 42. The motor 38 and the encoder 41 are likewise connected to the control device 42.

During a printing operation, the coupling 36 is engaged, so that a torque is transmitted from the main drive train to the journal 11 by the gear wheel 28. During the printing operation, the inner ring 32 of the bearing 31 revolves at the same angular speed as the outer ring 33. The antifriction elements 34 do not run on the respective running surfaces in the inner ring 32 and outer ring 33. Without a supply of a lubricating oil, the antifriction elements 34 would undesirably work into the running surfaces.

Because of the restricted space, the lubricating oil cannot be fed directly to the bearing 31. The oil is fed to the bearing 31 through a duct 43 which runs axially in the journal 11. The duct 43 connects two grooves 44 and 45, which are machined in the journal 11 at an axial distance from one another. A hole 46 drilled into the inner ring 32 leads from the groove 45 to a bearing chamber of the antifriction elements 34. An inner ring 47 of a ball bearing 48 is seated over the groove 44. An outer ring 49 of the ball bearing 48 is fixed to a support 50 which is, in turn, fixedly connected to the frame of the side wall 1. An oil feed drilled hole or bore 51 is introduced into the outer ring 49. At least one oil discharge drilled hole 52, which runs in the inner ring 47, leads from the bearing chamber of the balls of the bearing 48 to the groove 44. The bearing 48 is provided at the sides thereof with seals 53, 54. The drilled hole 51 extends from the bearing chamber of the balls of the bearing 48 to a flexible pipe connecting piece 55, which is screwed into the support 50. A flexible pipe 56 connects the drilled hole or bore 51 to an oil pump 57. The pump 57 is a conveying device for conveying lubricant out of a stationary container 81. The inner ring 32 is fixed against displacement in the axial direction of the journal 11 by disks 58, 59.

When the pump 57 is started up, oil then flows through the drilled hole or bore 51, the bearing chamber of the bearing 48, the drilled hole or bore 52, the groove 44, the duct 43, the groove 45, the drilled hole or bore 46 and into the bearing chamber of the bearing 31. Excess oil emerges laterally from the bearing 31 and reaches an oil collecting trough by gravity.

The bearing 48 forms a rotary leadthrough for the lubricating oil of the bearing 31. The seals 53, 54 prevent the oil from flowing out quickly. The revolving of the balls effects a continuous flow of oil through the bearing 48. Leakage losses during the passage through the bearing 48 can be accepted as long as sufficient oil arrives in the bearing chamber of the bearing 31.

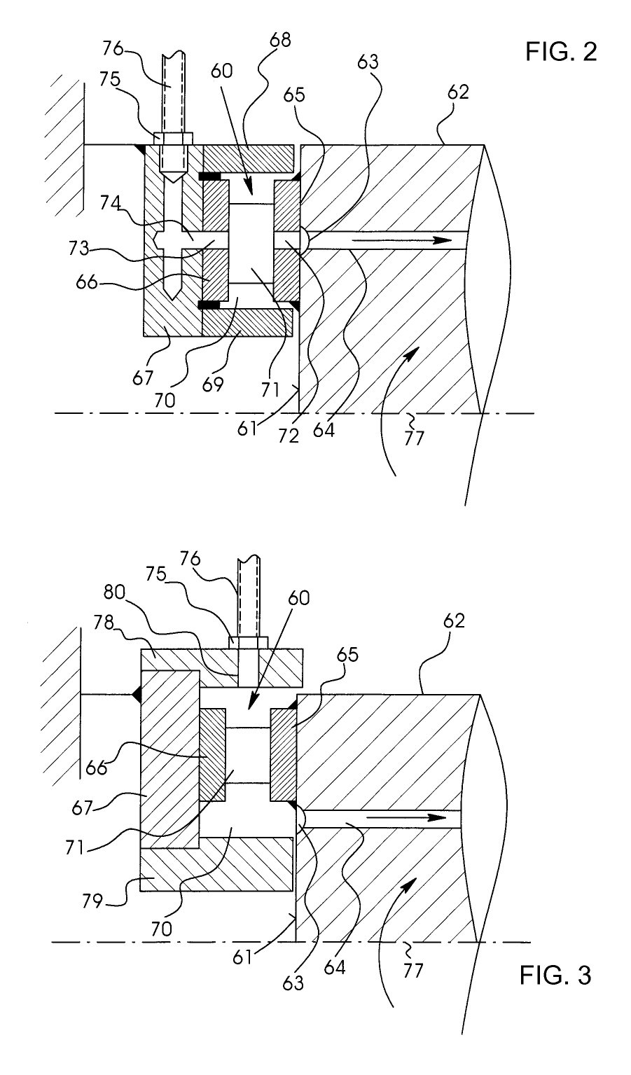

In a variation or variant embodiment according to FIG. 2, an axial roller bearing 60 is serves as a rotary leadthrough for lubricating oil. A groove 63 is machined in one end 61 of a journal 62 of a rotatably mounted cylinder. An axially extending duct 64 runs from the groove 63 to a lubrication point of a bearing on the journal 62 or on the cylinder. An inner ring 65 of the bearing 60 revolves with the journal 62. An outer ring 66 is fixed to a support 67, which is disposed fixed to the frame. In order to avoid oil leaks, sealing rings 68 and 69 are provided, which enclose the outer ring 60, the inner ring 65 and a chamber 70 wherein the rollers 71 are disposed. At least one oil discharge drilled hole or bore 72 in the inner ring 65 connects the groove 63 and the duct 64 to the bearing chamber 70 of the rollers 71. There is an oil feed drilled hole or bore 73 in the outer ring 66, which originates from the bearing chamber 70 and meets a duct 74 formed in the support 67. The duct 74 ends at a flexible pipe connecting piece 75, from which a flexible pipe 76 leads to an oil pump. By using the oil pump, lubricating oil is conveyed through the flexible pipe 76, the flexible pipe connecting piece 75, the duct 74, the drilled hole or bore 73, the chamber 70, the drilled hole or bore 72, the groove 63 and the duct 64 to the lubrication point. The oil flows through the bearing 60 in the direction of an axis of rotation 77 of the journal 62.

In a variant embodiment according to FIG. 3, an axial roller bearing 60 is enclosed by annular parts 78 and 79 and a support 67 fixed to the frame, in such a manner that no drilled holes 72, 73 as seen in FIG. 2 are needed in the rings 65, 66 to lead oil through. The oil is fed to the bearing chamber 70 of the bearing 60 through a drilled hole or bore 80 in the enclosing part 78, into which a flexible pipe connecting piece 75 is screwed. The oil is discharged from the bearing chamber 70 through a groove 63 and a duct 64 which, as described in relation to FIG. 2, are provided at the end 61 of a journal 62 of a cylinder. The groove 63 is located radially underneath the inner ring 65. The oil flows under pressure through the bearing 60 in the radial direction.

In the variant embodiment according to FIG. 3, the oil feed to the bearing chamber 70 can alternatively be provided through a drilled hole or a duct which is formed in the support 67 or between the support 67 and one of the enclosing parts 78, 79.

1. A configuration for feeding a lubricant to a lubrication point on a revolving part of a printing technology machine, the configuration comprising:
a stationary lubricant container;
a conveying device for conveying lubricant out of the container to the revolving part;
a sealed antifriction bearing disposed on the revolving part, said antifriction bearing having a bearing ring fixed against rotation and a bearing chamber for antifriction elements;
at least one lubricant feed duct extending to said bearing chamber; and
at least one lubricant duct disposed in the revolving part and leading from said antifriction bearing to the lubrication point.

2. The configuration according to claim 1, wherein, for feeding the lubricant, said antifriction bearing is a radial antifriction bearing having an outer ring and an inner ring, said lubricant feed duct extends through said outer ring, a lubricant drain duct extends through said inner ring, and said lubricant drain duct extends to said lubricant duct in the revolving part.

3. The configuration according to claim 1, wherein, for feeding the lubricant, said antifriction bearing is an axial antifriction bearing having an outer ring fixed against rotation and a bearing ring connected to the revolving part, said lubricant feed duct is led through said outer ring, a lubricant drain duct is led through said bearing ring, and said lubricant drain duct extends to said lubricant duct in the revolving part.

4. The configuration according to claim 1, wherein, for feeding the lubricant, said antifriction bearing is an axial antifriction bearing having an outer ring fixed against rotation and a bearing ring connected to the revolving part, said axial antifriction bearing is enclosed by enclosing parts fixed against rotation, and a lubricant feed duct is led to said bearing chamber through one of said enclosing parts or between two of said enclosing parts.

5. The configuration according to claim 1, wherein the lubricant is oil to be fed to said bearing chamber under pressure.
